(19) United States
(12) Patent Application Publication
(10) Pub. No.: US 2006/0119633 A1
(43) Pub. Date: Jun. 8, 2006

(54) Method of calibrating inkjet print head

(75) Inventors: Juei Tsang Hsu, Hsinchu (TW); Meng-Fen Lo, Hsinchu (TW); Hsiao-Yu Han, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/073,697

(22) Filed: Mar. 8, 2005

(30) Foreign Application Priority Data
Dec. 8, 2004 (TW) 93138023

(51) Int. Cl. B41J 29/393

(52) U.S. Cl. 347/19; 347/41

(57) ABSTRACT

A method of calibrating inkjet print head is disclosed to print a specially designed test pattern, including a plurality of first stripe patterns and several second patterns continuously printed and overlapped with each other. The overlapping between the first stripe patterns and the second patterns is checked. One overlapping state is extracted to find an optimal alignment condition, thereby calibrating the inkjet print head and enhancing the printing quality.

### BACKGROUND OF THE INVENTION

1. Field of Invention

The invention relates to a method of calibrating an inkjet print heads and, in particular, to a method of calibrating the print head of an inkjet printer by obtaining an optimal alignment condition through the retrieval of an overlapping state of test patterns.

2. Related Art

An inkjet printer for printing images and documents which are achieved by appropriate image and halftone processing, letting the print heads to have a reciprocal motion over a medium, and ejecting ink droplets at desired location through numerous nozzles. Generally speaking, a print head on a cartridge has numerous nozzles arranged in parallel, as shown in FIGS. 1A to 1D representing the print heads of black, cyan, magenta, and yellow colors. To achieve the photographic quality printing, the print heads have to be aligned and calibrated before reciprocal printing. Such calibration includes the reciprocal printing of the nozzles 11, or the one-way calibration of the nozzles 11, 13 to make sure that the ink droplets will be ejected at correct places. Normally, the ejection of ink droplets relies on a position decoder, such as an optical ruler, that generates a synchronization signal for ink ejection. When the print head reaches the same position as it travels back and forth, the ink droplet should be ejected to the same position. However, as the print head travels with a transverse speed, the ejected ink will travel horizontally a certain distance before reaching the medium. For the optical rule signal at the same position, the ink droplets flying to the left and to the right will result in deviations in the ink printing position on a medium. Moreover, some printers even have different traveling speeds to the left and to the right. This will make the deviation more serious. Therefore, the printing quality will be poor if the print head is not calibrated.

To solve the above problems, the U.S. Pat. No. 5,289,208 provides a method of calibrating the print heads. As shown in FIG. 2A, the print head of a first color prints vertical lines 10 from left to right at fixed intervals as reference lines. The print head of a second color then prints another set of vertical lines 12 from left to right. The second set of vertical lines 12 has pre-determined intervals and adjacent to the first set of vertical lines 10 as a means to calibrate the print heads of different colors in the same printing direction. Alternatively, as shown in FIG. 2B, the method can calibrate the print head in bi-directional printing. First, it prints a set of vertical lines 14 from left to right at fixed intervals, then another set of vertical lines 16 from right to left also at fixed intervals by the same print head. In the end, an optical scanning device is used to scan the vertical lines 10 and 12, 14 and 16 to obtain a best alignment condition. The method has to employ an optical scanning device to scan an upper half part and a lower half part and to determine the location of the vertical lines in the upper and lower half parts before determining the optimal alignment condition. Therefore, it is time-consuming.

As shown in FIG. 3, the method used in the U.S. Pat. No. 6,390,587 is to print a set of test patterns 20 on a medium. The test patterns 20 include bars 22 printed by the print head of a first color and bars 24 printed by the print head of a second color. The two sets of bars 22, 24 are interlaced and repeated. Generally, the spatial frequency formed by the two sets of bars 22, 24 should have a pre-determined phase difference, for example, 180° of 180°. An optical scanning device is used to detect the reflectance of the test patterns 20, thereby obtaining the phase difference between the two sets of bars 22, 24. The phase difference is used to calibrate single directional printing of two colors. This can render an optimal alignment condition. Likewise, the method can be applied to the calibration of both way bi-directional printing of the same color. This method has to calculate the location of each bar printed by the print head of a first color and those of each bar printed by the print head of a second color, and then compute the phase difference between them. The computation is complicated and time consuming.

### SUMMARY OF THE INVENTION

In view of the foregoing, the invention provides a method of calibrating print heads. It employs a set of specially designed test patterns. By detecting the overlapping state of the test patterns, the method obtains an optimal alignment condition. It achieves the goal of automatically calibrating the print head for alignment, thus solving the problems existing in the prior art.

To achieve the above objective, the disclosed method of calibrating print heads include the steps of: printing a plurality of first stripe pattern sets, each of which is composed of a plurality of first stripe patterns at fixed distance in parallel; printing a plurality of second patterns, each of which overlaps with part of the first stripe pattern sets, detecting the overlapping state of the first stripe pattern set and the second pattern; analyzing the information of each overlapping state and finding an optimal alignment condition from one overlapping state to calibrate print heads.

### BRIEF DESCRIPTION OF THE DRAWINGS

The invention will become more fully understood from the detailed description given hereinbelow illustration only, and thus are not limitative of the present invention, and wherein:

FIGS. 1A to 1D show respectively the print heads of black, cyan, magenta, and yellow colors in the prior art;

FIGS. 2A and 2B are schematic views of the test patterns used in the calibration of print heads of different colors in a single direction and the calibration of the print head of one color in both directions in the prior art;

FIG. 3 is a schematic view of the test patterns used in the print head calibration according to another conventional method;

FIG. 4 is a flowchart of the disclosed method of calibrating print heads;

FIGS. 5A to 5D are schematic views of the test patterns used in the calibration of a monochromatic print head in both directions according a first embodiment of the invention;

FIGS. 6A to 6D show the curves of the averaged reflectance of the test patterns in FIGS. 5A to 5D, respectively, extracted using an optical scanning device;

FIGS. 7A to 7D are schematic views of the test patterns used in the calibration of print heads of two colors in a single direction according a second embodiment of the invention;

FIG. 8 is a schematic view of the test patterns in a third embodiment of the invention;

FIG. 9 is a schematic view of the test patterns in a fourth embodiment of the invention;

FIG. 10 is a schematic view of the test pattern that is hard to make correct detection;

FIGS. 11A to 11J show the theoretical variations in the reflection signals as the photo detector used in the invention scans through the test patterns;

FIG. 12 shows the theoretical reflection signal intensity curves for FIGS. 11A to 11J;

FIGS. 13A to 13J show the theoretical variations in the reflection signals as the photo detector used in the invention scans through the test patterns under the optical alignment condition;

FIG. 14 shows the theoretical reflection signal intensity curves for FIGS. 13A to 13J and compares with the curve slopes in FIG. 12; and

FIGS. 15A and 15B show the test pattern formed by first and second color and the corresponding reflection signals respectively.

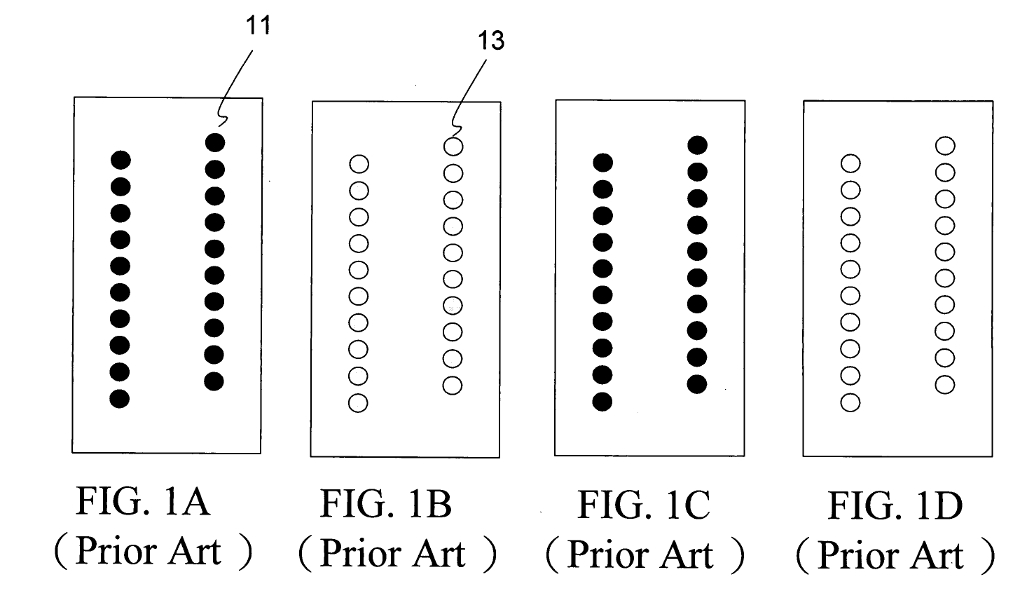

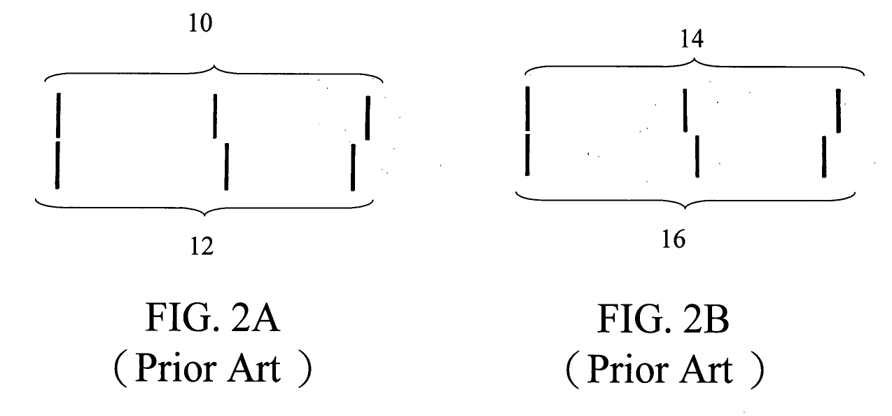

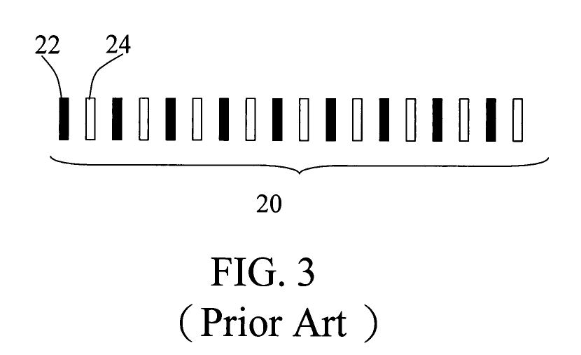

### DETAILED DESCRIPTION OF THE INVENTION

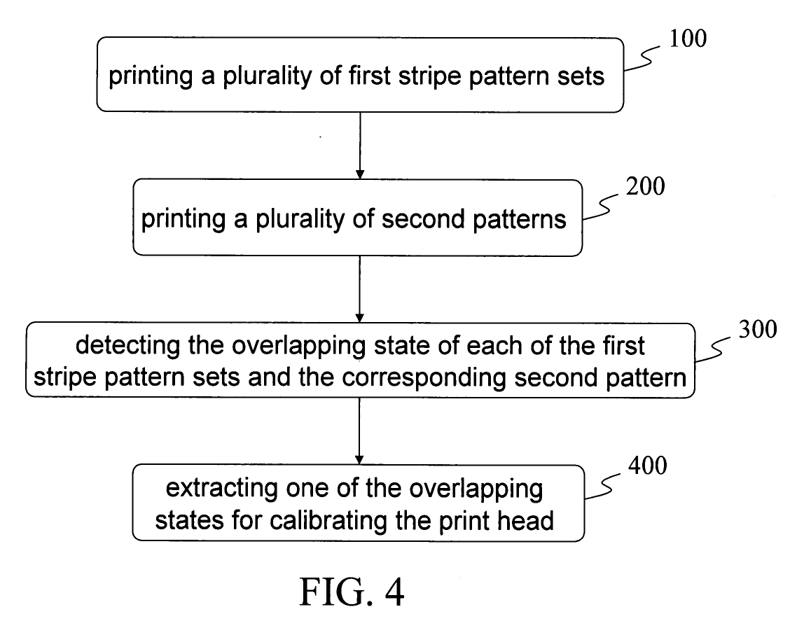

As shown in FIG. 4, the main procedures of the disclosed print head calibration method include the following steps. First, several first stripe pattern sets are printed (step 100). Each of the first stripe pattern sets contains several first stripe patterns at fixed intervals in parallel. Afterwards, several second patterns are printed (step 200). Each of the second patterns overlaps with part of the first stripe pattern sets. The overlapping state of the first stripe pattern sets and the second patterns are detected in sequence (step 300). Finally, make a best decision depends on said overlapping state to calibrate print head (step 400).

In the following, we use several embodiments to explain the details of the invention.

In the embodiments of the invention, an inkjet printer with the printing function is used. When the printer detects that a new print head is installed of receives a calibration command from the user, the printer automatically prints the test patterns.

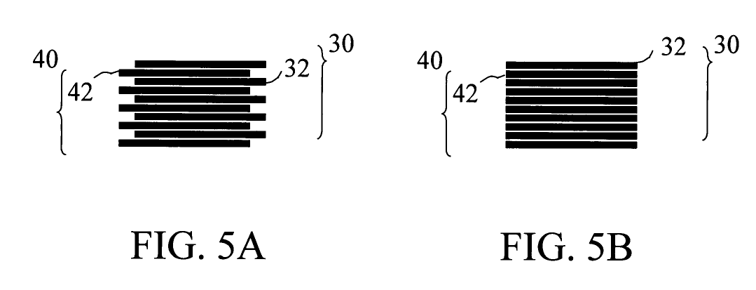

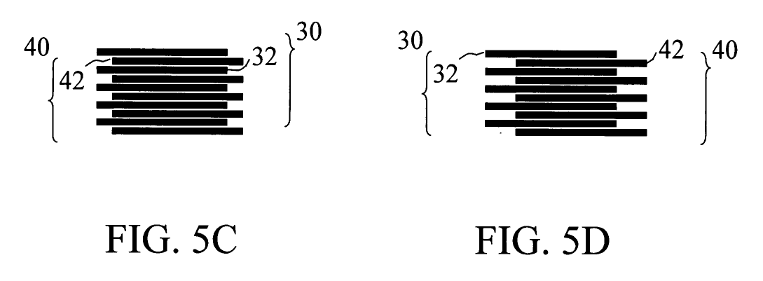

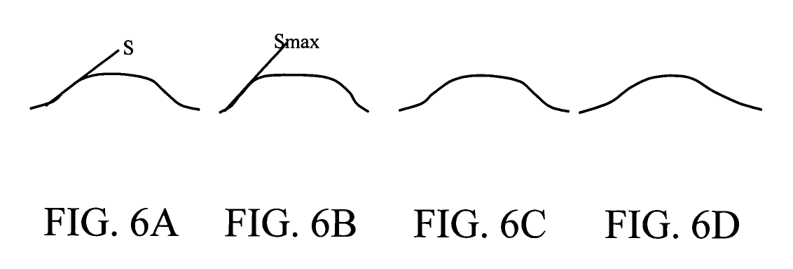

As shown in FIGS. 5A to 5D, the test patterns for calibrating a monochromatic print head in one direction consist of the first stripe pattern sets 30, each of which is composed of several first stripe patterns 32 printed from right to left (step 100), and second patterns 40, each of which composed of several second stripe patterns 42 from left to right (step 200). Each of the first stripe patterns 32 and the second stripe patterns 42 are horizontal stripes at fixed intervals in the vertical direction. They are interlaced with each other. An optical scanning device is then employed to get the average reflectance of the test patterns or the inverted background reflectance composed of the first stripe pattern sets 30 and the second patterns 40 in FIGS. 5A to 5D. As shown in FIGS. 6A to 6D, the overlapping state between the first stripe pattern sets 30 and the second patterns 40 is checked (step 300). If the slope of the positive edge of the signal S reaches a maximum Sₘₐₓ, as shown in FIG. 6B, it means that the first stripe pattern sets 30 have the best overlap with the second patterns 40 in the vertical direction (paper feed-in direction). As shown in FIG. 4B, under the predetermined deviation, the print head has the optimal alignment condition. Using the set of deviation parameters ensures the best printing quality (step 400).

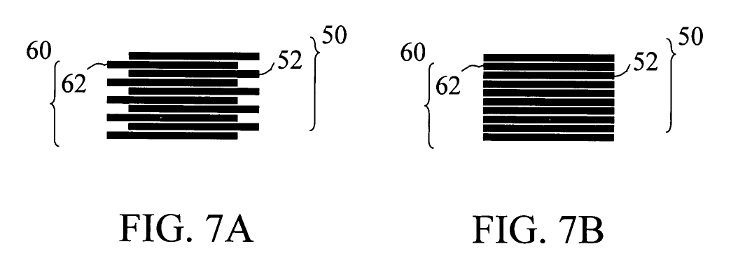

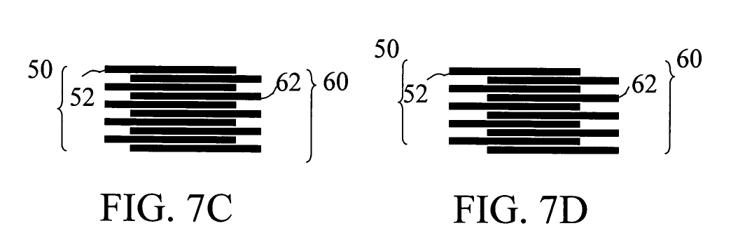

FIGS. 7A to 7D show the test patterns used for the calibration of print heads of different colors in single direction according to a second embodiment of the invention. The major difference between this embodiment and the first embodiment is that the current embodiment first makes the print head of a first color print the first stripe pattern set 50 composed of several first stripe patterns 52 from right to left (step 100). The print head of a second color prints the second pattern 60 composed of several second stripe patterns 62 along the same direction (step 200). Afterwards, an optical scanning device scans the average reflectance of the test pattern composed of the first stripe pattern set 50 and the second pattern 60 in FIGS. 7A to 7D and the overlapping state between the first stripe pattern set 50 and the second pattern 60 is measured (step 300). When the slope at the positive edge of the signal reaches its maximum, it means that the first stripe pattern set 50 and the second pattern 60 have the best overlapping in the vertical direction (paper feed-in direction), as shown in FIG. 7B. The deviation parameters are extracted to find an optimal alignment condition of the print head, ensuring the best printing quality (step 400).

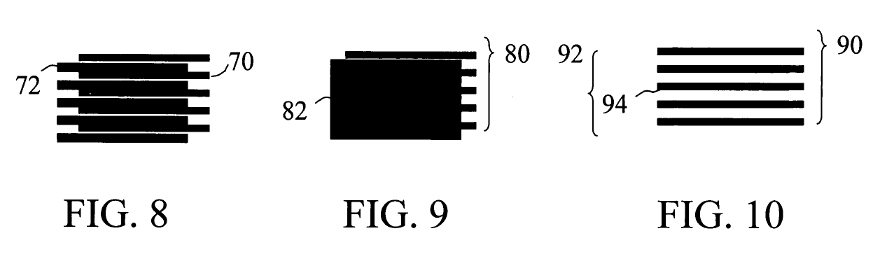

The widths of the first stripe pattern in the first stripe pattern set and the second stripe pattern in the second pattern are the same as the above-mentioned embodiment. In practice, their widths can be different. As shown in FIG. 8, the third embodiment of the invention has wider second stripe patterns 72 than the first stripe patterns 70.

In the test patterns in the fourth embodiment, as shown in FIG. 9, the second pattern 82 is a block pattern and overlaps partially with the first stripe pattern set 80. This can avoid the situation shown in FIG. 10. The drawing shows that the first stripe pattern set 90 with horizontal lines and the second stripe patterns 94 of the second pattern 92 overlap in the horizontal direction. When using the average reflectance of the test patterns to determine the overlapping state of the first stripe pattern set 90 and the second pattern 92, there will not be significant differences in the reflected signal, resulting in difficult decisions.

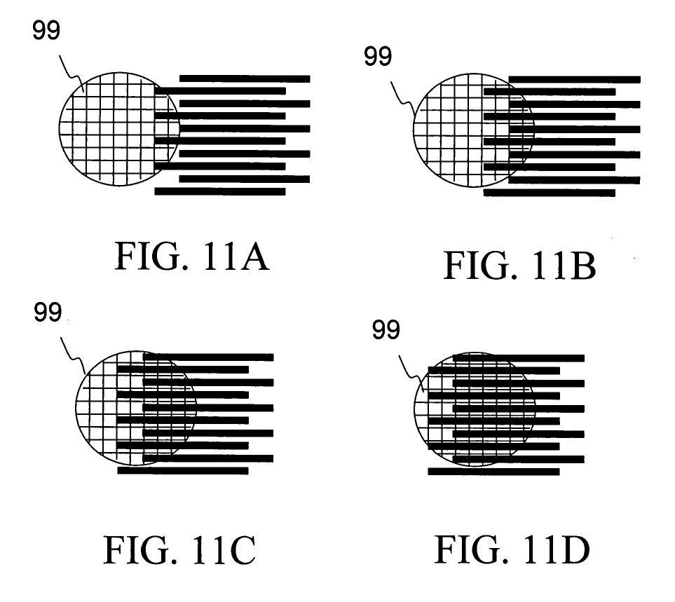

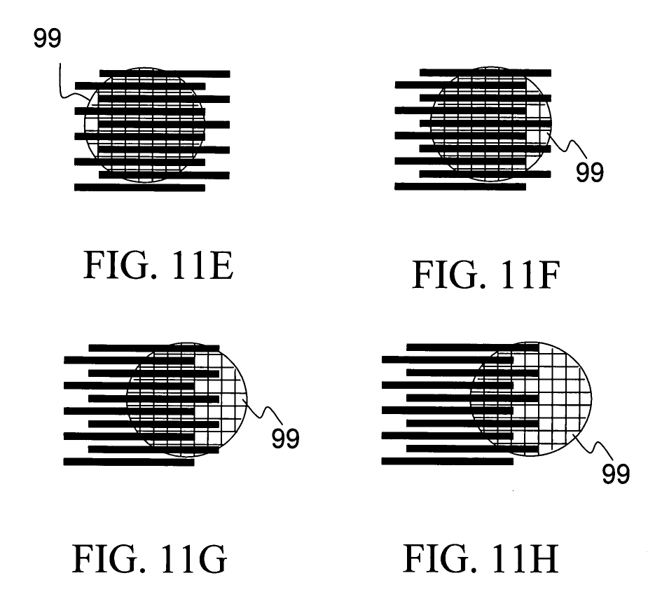

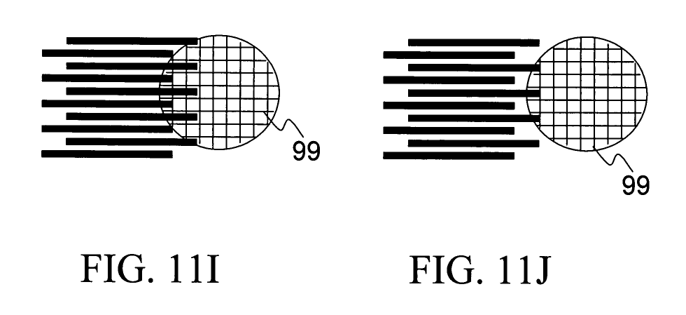

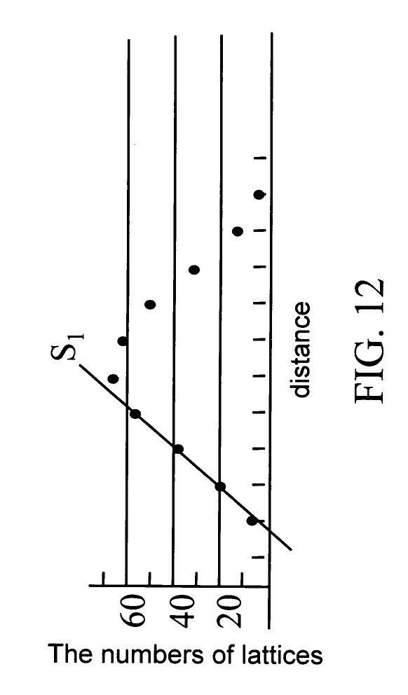

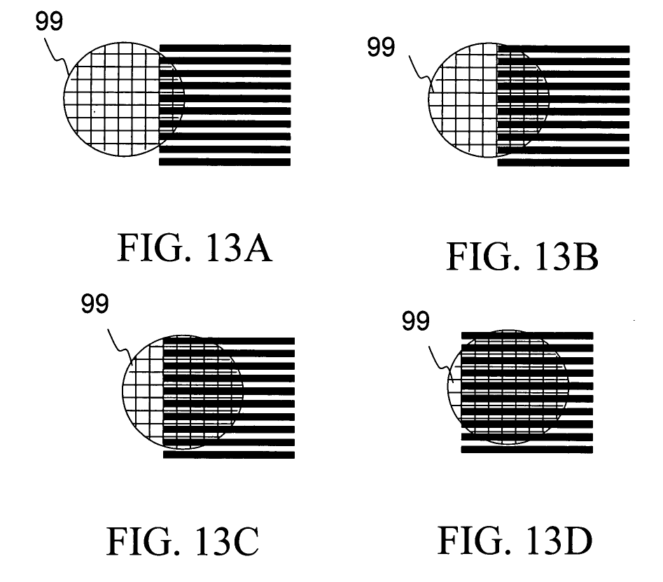

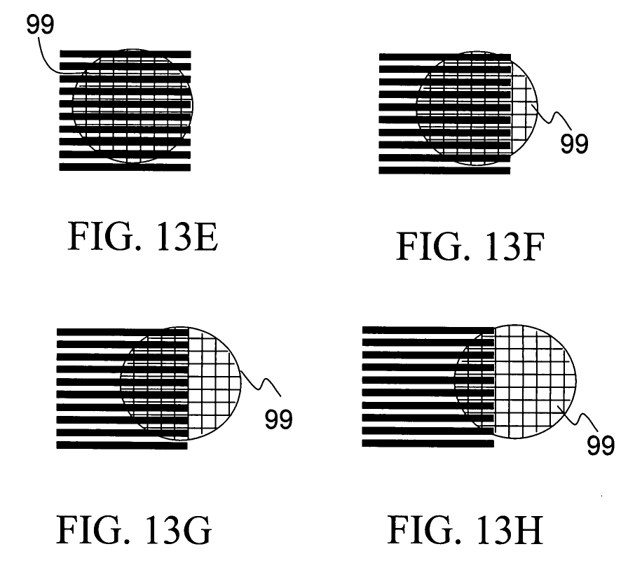

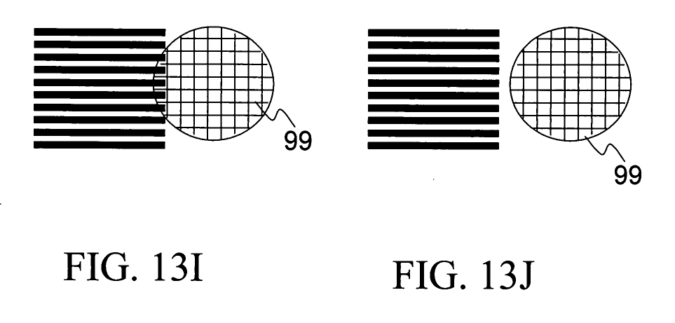

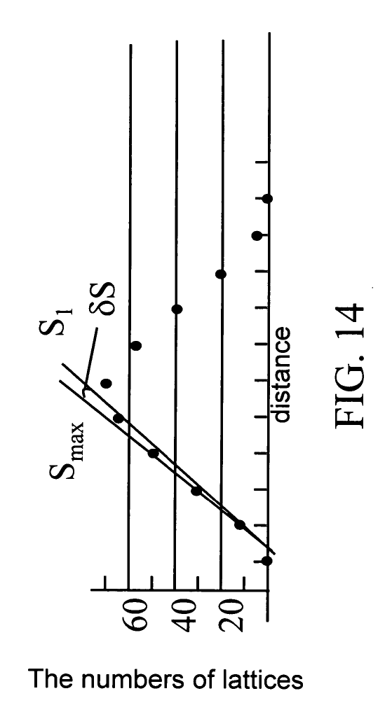

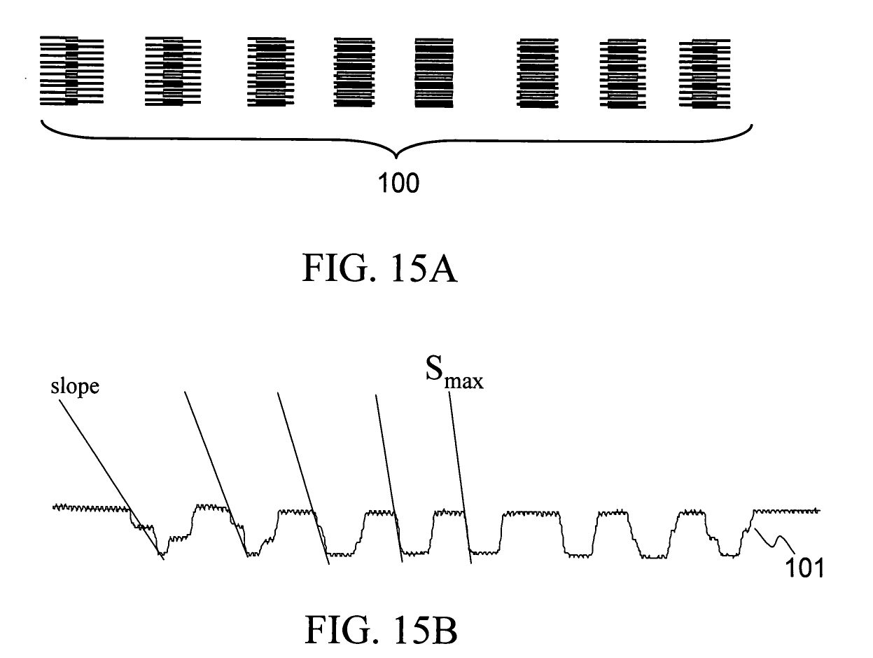

It should be mentioned that FIGS. 11A to 11J show the theoretical variations of the reflection signals of the test patterns detected by the photo sensor 99. As the photo sensor 99 passes through the test patterns, it detects the reflection signals of the test patterns, obtaining many sets of reflection signals. Suppose the test pattern proceeds one unit of distance (here as a fixed number of pixels) within a unit time and the signal strength detected by the photo sensor is proportional to the intensity of the reflected light, then each set of reflection signal detected by the photo sensor 99 can be counted using the corresponding lattice. The numbers of lattices in FIGS. 11A to 11J are, respectively, 6, 20, 38, 56, 67, 63, 50, 31, 13, and 3. The signal strength curve relating the signal strength and the test pattern position can be drawn, as shown in FIG. 12. Analyzing the slope S₁ of the curve, one can see that a slope maximum Sₘₐₓ can be found under the optimal alignment condition. FIGS. 13A to 13J show the theoretical variations of the reflection signals as the photo sensor 99 scans over the test patterns under the optimal alignment condition. FIG. 14 shows the signal strength curve relating the signal strength and the test pattern position. It also shows that the slope difference δS between Sₘₐₓ and S₁. Utilizing this principle, we can find the optimal alignment parameter of the print head. When the actual measurement is the reflection signal of the paper background, the reflection signal waveform will be reversed. The experiment as shown in FIGS. 15A and 15B shows well consistent with the mentioned analysis. In FIG. 15A, the test pattern 100 is formed by first and second color. In FIG. 15B, the reflection signals 101 is corresponding with the test pattern 100. However, the steepest part slope Sₘₐₓ still corresponds to the optimal alignment condition.

In summary, the disclosed print head calibration method uses specially designed test patterns to directly compute based upon the printed results. Its computation process is simple and quick. In particular, by testing the reflection signals of the test patterns and analyzing the slope at the positive edge of the reflection signals, the optimal alignment condition is obtained by finding the largest slope. This achieves the objective of calibrating the print head and obtaining high printing quality.

Certain variations would be apparent to those skilled in the art, which variations are considered within the spirit and scope of the claimed invention.

What is claimed is:

1. A method of calibrating a print head, comprising the steps of:
printing a plurality of first stripe pattern sets, each of which contains a plurality of first stripe patterns at fixed intervals in parallel;
printing a plurality of second patterns, each of which overlaps with one of the first stripe pattern sets;
detecting the overlapping state of each of the first stripe pattern sets and the corresponding second pattern; and
extracting one of the overlapping states for calibrating the print head.

2. The method of claim 1, wherein the firs stripe pattern sets and the second patterns are formed by one print head using back printing.

3. The method of claim 1, wherein the first stripe pattern sets and the second patterns are formed by different print heads printing successively.

4. The method of claim 1, wherein each of the second patterns contains a plurality of parallel second stripe patterns at fixed intervals and alternates among the first stripe patterns.

5. The method of claim 4, wherein the second stripe patterns and the first stripe patterns have the same interval.

6. The method of claim 5, wherein each of the first stripe patterns and each of the second stripe patterns have the same width.

7. The method of claim 1, wherein the second pattern is a block pattern partially overlapping with the first stripe pattern set.

8. The method of claim 1, wherein the step of detecting in sequence the overlapping state of each of the first stripe pattern sets and the corresponding second pattern is achieved by detecting the reflection signal of each of the first stripe pattern sets and each of the second patterns.

9. The method of claim 8, wherein the extracted overlapping state is the one corresponding to the reflection signal with the largest slope.

10. The method of claim 8, wherein the step of detecting the reflection signal of each of the first stripe pattern sets and each of the second patterns includes the steps of:
detecting in sequence each of the first stripe pattern sets and each of the second patterns to obtain a plurality of reflection signal sets;
forming a plurality of signal strength curves according to the reflection signal sets that correspond to the overlapping states; and
computing the slope of each of the signal strength curve.

11. The method of claim 10, wherein the extracted overlapping state is the one corresponding to the signal strength curve with the largest slope.
